(19) United States
(12) Patent Application Publication
(10) Pub. No.: US 2010/0278007 A1
(43) Pub. Date: Nov. 4, 2010

(54) Stirring Apparatus

(75) Inventors: Philippe Andre Tanguy, Outremont (CA); Louis Fradette, Blainville (CA); Guillaume Thome, Cambrai (FR)

Correspondence Address: THE WEBB LAW FIRM, P.C., 700 KOPPERS BUILDING, 436 SEVENTH AVENUE, PITTSBURGH, PA, 15219, US

(73) Assignee: Sumitomo Heavy Industries Process Equipment Co. ,, Saijo-shi, Ehime (JP)

(21) Appl. No.: 12/680,068

(22) PCT Filed: Sep. 25, 2007
(86) PCT No.: PCT/JP2007/068587

§ 371 Date: Jun. 30, 2010

(51) Int. Cl. B01F 13/00

(52) U.S. Cl. 366/343

(57) ABSTRACT

It is an object of the present invention to provide a stirring apparatus which can exhibit excellent stirring characteristics in a wide range of viscous regions and which can reduce the mixing time. A stirring apparatus includes a stirred tank having a bottomed cylinder shape, a rotation shaft concentrically or substantially concentrically disposed inside the stirred tank, and a bottom blade that extends from the rotation shaft so as to extend in a radial direction and a vertical direction, of the stirred tank, and a lower edge of the bottom blade has a shape conforming to a bottom wall surface of the stirred tank. Here, a clearance is formed between the lower edge of the bottom blade and the lower wall surface and the clearance satisfies the following condition: 1% of the inner diameter of the stirred tank<the clearance<4.5% of the inner diameter of the stirred tank.

### TECHNICAL FIELD

The present invention relates to a stirring apparatus for performing an stirring treatment for the purpose of mixture, dissolution, crystallization, reaction, and the like.

### BACKGROUND ART

Hitherto, various types were suggested as stirring apparatus for performing stirring treatment for the purpose of mixture, dissolution, crystallization, reaction, and the like. As an example of them, there is known a stirring apparatus in which a bottom blade is disposed in a lower area of a stirred tank.

In such a stirring apparatus, the bottom blade is disposed orthogonal to a rotation shaft concentrically or substantially concentrically disposed in the stirred tank and a lower edge of the bottom blade is disposed to be close to a bottom wall surface of the stirred tank. The bottom blade may have a flat plate shape, have such a shape that a rotation shaft side is formed in a flat plate shape and an edge side is curved in the rotation direction, or may have a plate shape twisted from the rotation shaft to the edge, all the lower edges of which are formed in a shape conforming to the lower wall surface of the stirred tank.

In the stirring apparatus, since the bottom blade is disposed in the lower area of the stirred tank, an object to be stirred (or a stirring object) in the stirred tank is pumped in the radial direction of the stirred tank in the lower area (bottom area) by the rotation of the bottom blade. Accordingly, the stirring object pumped in the radial direction of the stirred tank forms a primary circulating flow, which collides with a peripheral wall of the stirred tank, moves upward to the vicinity of the liquid level, moves to the center of the stirred tank in the vicinity of the liquid level, moves downward at the center of the stirred tank, and then returns to the bottom blade.

The stirring apparatus having such a bottom blade can deal with a wide range of flow conditions from a turbulent flow region to a laminar flow region by forming a large circulating flow across the entire stirred tank from the bottom of the stirred tank to the liquid level.

### SUMMARY OF THE INVENTION

### Problems that the Invention is to Solve

As described above, the stirring apparatus having the above-mentioned configuration can deal with a wide range of flow conditions, but, in the laminar flow region, a stirring object pumped in the radial direction of the stirred tank collides with the peripheral wall of the stirred tank and is separated into an upward flow and a downward flow which respectively turn into a primary circulating flow and a secondary circulating flow. In the primary circulating flow, a stirring object collided with the peripheral wall of the stirred tank moves upward to the vicinity of the liquid level, moves to the center of the stirred tank in the vicinity of the liquid level, then moves downward at the center of the stirred tank, and then returns to the bottom blade. On the other hand, in the secondary circulating flow, a stirring object collided with the peripheral wall of the stirred tank moves along the bottom wall surface, moves upward at the center of the stirred tank, and then returns to the bottom blade. Since the bottom blade of the stirring apparatus having the above configuration is disposed to be close to the bottom surface of the stirred tank, the primary circulating flow and the secondary circulating flow become independent flows in the laminar flow region, and it is tended that the liquid is not easy or not possible to be exchanged between the primary circulating flow and the secondary circulating flow. Consequently, there is a problem in that it take a long time to carry out stirring treatment of a stagnated region existing in the center portion of the secondary circulating flow. Especially, as the Re number decreases, this phenomenon becomes more significant.

Accordingly, it is an object of the invention to provide a stirring apparatus which can exhibit excellent stirring characteristics in a wide viscous area and which can reduce the mixing time.

### Means for Solving the Problems

According to an aspect of the invention, there is provided a stirring apparatus comprising a stirred tank having a bottomed cylinder shape, a rotation shaft concentrically or substantially concentrically disposed inside the stirred tank, and a bottom blade that extends from the rotation shaft so as to extend in a radial direction and a vertical direction, of the stirred tank, a lower edge of the bottom blade having a shape conforming to a bottom wall surface of the stirred tank, wherein a clearance is formed between the lower edge of the bottom blade and the lower wall surface and the clearance satisfies the following condition: 1% of the inner diameter of the stirred tank<the clearance<4.5% of the inner diameter of the stirred tank.

It was confirmed through experiments that the stirring apparatus having the above-mentioned configuration can perform an excellent stirring treatment in a wide range of flow conditions and can reduce the mixing time. This is because the independency between the primary circulating flow and the secondary circulating flow is broken and thus liquid exchanging becomes possible by setting the clearance between the lower edge of the bottom blade and the bottom wall surface of the stirred tank to an optimal value, the clearance satisfying the following condition: 1% of the inner diameter of the stirred tank<the clearance<4.5% of the inner diameter of the stirred tank, in which, in the laminar flow region, a stirring object of the primary circulating flow is pumped by the bottom blade, moves upward to the vicinity of the liquid level, moves to the center of the stirred tank in the vicinity of the liquid level, moves downward at the center of the stirred tank, and then returns to the bottom blade; and, also in the laminar flow region, a stirring object of the secondary circulating flow is pumped by the bottom blade, moves along the bottom wall surface, moves downward at the center of the stirred tank, and then returns to the bottom blade. Thus, according to the stirring apparatus having the above-mentioned configuration, liquid exchanging of a stirring object is made between the primary circulating flow and the secondary circulating flow in the laminar flow region, thereby enabling stirring to be made in a short time. Whereby, the stirring apparatus having the above-mentioned configuration makes it possible to achieve excellent stirring in a wide range of viscous regions in a short time.

### ADVANTAGES OF THE INVENTION

According to the present invention described above, it is possible to produce excellent effects, that is, exhibit excellent stirring characteristics in a wide range of viscous regions, and thus to reduce the mixing time.

### BRIEF DESCRIPTION OF THE DRAWINGS

FIG. 1 is a front view schematically illustrating a stirring apparatus according to an embodiment of the present invention.

FIG. 2 is an explanatory diagram schematically illustrating a flow of an stirring object in the stirring apparatus according to the embodiment.

FIG. 3 is an explanatory diagram schematically illustrating a stirring apparatus according to an example of the present invention.

FIG. 4 is a graph illustrating an experimental result according to the example.

### DESCRIPTION OF REFERENCE NUMERALS AND SIGNS

1: STIRRED TANK
2: ROTATION SHAFT
3: STIRRING IMPELLER
10: PERIPHERAL WALL
11: PERIPHERAL WALL SURFACE
12: BOTTOM
13: BOTTOM WALL SURFACE
30: BOTTOM BLADE
31: LATTICED BLADE
310: ARM
311: STRIP
M: STIRRING OBJECT
Ra: PRIMARY CIRCULATING FLOW
Rb: SECONDARY CIRCULATING FLOW

### BEST MODE FOR CARRYING OUT THE INVENTION

Hereinafter, a stirring apparatus according to an embodiment of the invention will be described with reference to the accompanying drawings.

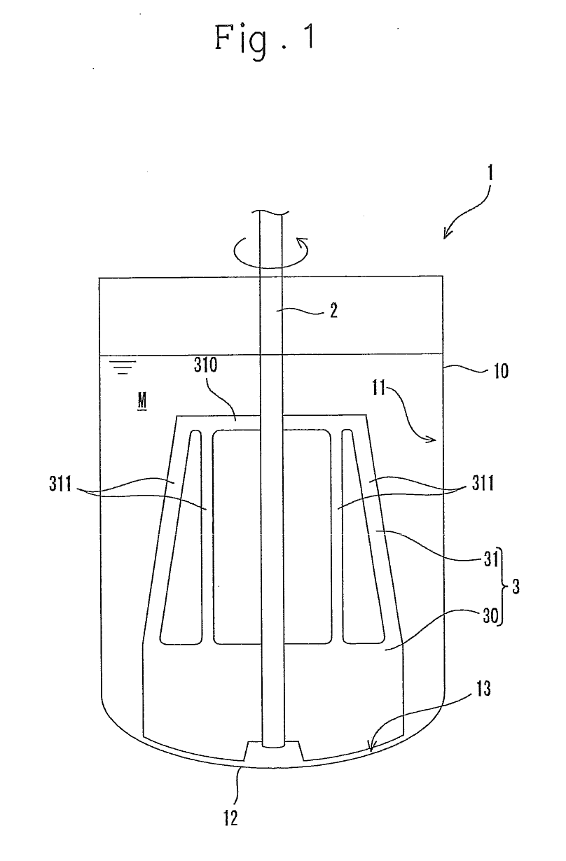

As shown in FIG. 1, a stirring apparatus according to this embodiment includes a stirred tank 1 having a bottomed cylinder shape, a rotation shaft 2 disposed at the center of the stirred tank 1, and a stirring impeller 3 attached to the rotation shaft 2.

The stirred tank 1 is a bottomed cylinder-shaped container in which a peripheral wall 10 forms a cylindrical shell shape. A bottom 12 of the stirred tank 1 is formed so that a bottom wall surface 13 has a substantially circular arc-shaped (semi-elliptical arc shaped) section.

The rotation shaft 2 has an upper end protruding out of the stirred tank 1 through an upper portion thereof and a lower end extending down to the vicinity of the bottom wall surface 13. The protruding upper end is connected to a driving device (not shown) outside the stirred tank 1 through a coupling (not shown). The rotation shaft 2 may be axially supported close to the upper end of the stirred tank 1 or the lower end of the rotation shaft may be supported by a bearing (not shown) disposed at the center of the bottom wall surface 13 of the stirred tank 1. The driving device for driving the rotation shaft 2 may be disposed in the vicinity of the bottom 12 of the stirred tank 1 instead of the upper side of the stirred tank 1.

The stirring impeller 3 includes a bottom blade 30 which extends from the rotation shaft 2 and which is disposed in a lower area of the stirred tank 1. In addition to the bottom blade 30, the stirring impeller 3 according to this embodiment further includes a latticed blade 31 formed of a vertical and horizontal band-shaped plate extending above the bottom blade 30.

The bottom blade 30 is connected to the rotation shaft 2 so as to extend in a radial direction and a vertical direction, of the stirred tank 1. The bottom blade 30 according to this embodiment is formed in a flat plate shape and employs so-called bottom paddles extending along the axial line of the rotation shaft 2 to both sides of the rotation shaft 2. The bottom blade 30 has a lower edge having a shape conforming to the bottom wall surface 13. That is, the bottom blade 30 has a lower edge formed in a substantially circular arc shape (elliptical arc shape).

The bottom blade 30 is disposed so that the clearance between the lower edge of the bottom blade 30 and the bottom wall surface 13 of the stirred tank 1 satisfies the condition: 1% of the inner diameter of the stirred tank 1 (peripheral wall 10)<the clearance<4.5% of the inner diameter of the stirred tank 1 (peripheral wall 10). In other words, the bottom blade 30 is fixed to the rotation shaft 2 in a state where the rotation shaft 2 is axially supported to be concentric with the stirred tank 1 so that the clearance between the lower edge of the bottom blade 30 and the bottom wall surface 13 of the stirred tank 1 satisfies the condition: 1% of the inner diameter of the stirred tank 1<the clearance<4.5% of the inner diameter of the stirred tank 1.

The latticed blade 31 extends above the bottom blade 30 and includes an arm 310 extending in the horizontal direction (radial direction) and strips 311 extending in the vertical direction. In this embodiment, the arm 310 and the strips 311 each are formed in a band plate shape. In this embodiment, the latticed blade 31 includes one arm 310 and four strips 311, and the upper end of each strip 311 is connected to the arm 310. Two strips disposed on the outside in the diameter direction among the four strips 311 are disposed to come close to each other as they advance upward. That is, the two outside strips 311 are tilted so as to come close to the rotation shaft 2 as they advance upward.

In this embodiment, the bottom blade 30 and the latticed blade 31, of the stirring impeller 3 are formed integrally with each other. That is, in the stirring impeller 3 according to this embodiment, the lower end of each strip 311 of the latticed blade 31 is connected to the upper end of the bottom blade 30. In this embodiment, the bottom blade 30 and the latticed blade 31 are formed integrally with each other to form the stirring impeller 3. However, for example, the bottom blade 30 and the latticed blade 31 may be formed independently of each other and connected to each other to form the stirring impeller 3. In this case, the bottom blade 30 and the latticed blade 31 may be disposed close to each other, or the bottom blade 30 and the latticed blade 31 may be disposed separate from each other so that a small gap exists between the bottom blade 30 and the latticed blade 31.

The stirring apparatus according to this embodiment has the above-mentioned configuration and the stirring characteristics of the stirring apparatus according to this embodiment will be described hereinafter.

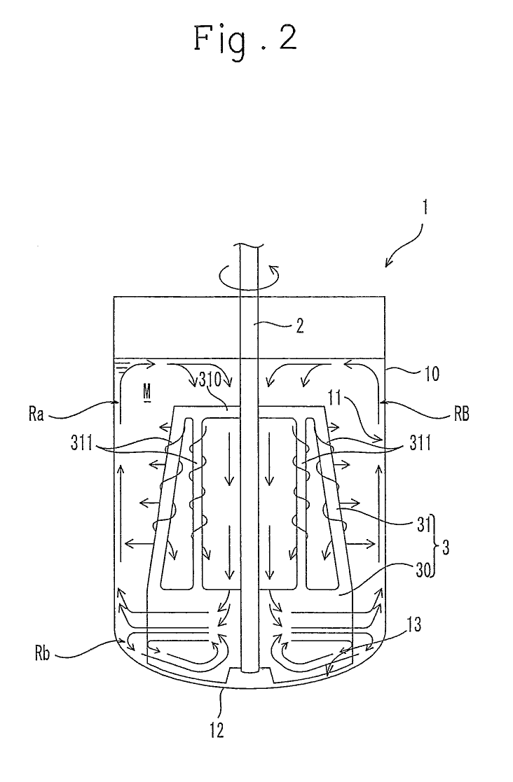

As shown in FIG. 2, with the rotation of the stirring impeller 3, the stirring object M in the stirred tank 1 is first pumped or moved outward in the radial direction from the vicinity of the rotation shaft 2 by the bottom blade 30. That is, the stirring object M in the stirred tank 1 is pumped outward in the radial direction by any substantial portion of the bottom blade 30, and collides with the peripheral wall surface 11. The stirring object M collided with the peripheral wall surface 11 is separated into an upward flow and a downward flow in a laminar flow region along the peripheral wall surface 11. The upward stirring object M moves upward along the peripheral wall surface 11 while being pressed onto the peripheral wall 10 by the stirring object M pumped by the strips 311 rotating around the rotation shaft 2.

The stirring object M which has moved upward to the vicinity of the liquid level moves toward the center (rotation shaft 2) of the stirred tank 1, then moves downward from the vicinity of the rotation shaft 2 and the uppermost arm 310 of the latticed blade 31, and then returns to the bottom blade 30, thereby forming a large primary circulating flow Ra in the stirred tank 1.

In this primary circulating flow Ra, the downward flow of the stirring object M is sheared finely by the strips 311. The finely sheared downward flow rolls up into minute vortices occurring on the downstream side of the arm 310 and the strips 311, thereby stirring the stirring object M. Since the arm 310 and the strips 311 serve to pump the stirring object M in the radial direction at the same time, they serve to press the upward flow of the stirring object M, which is moving up along the peripheral wall surface 11, to the peripheral wall surface 11 as described above. Since the outside strips 311 each have a shape having a distance from the rotation shaft 2 increasing as each advances downward, the flow rate of the pumped stirring object M increases as it moves downward. As a result, it is possible to efficiently stir the stirring object M thanks to the synergic effect thereof.

On the other hand, the stirring object M moving downward along the peripheral wall surface 11 moves along the bottom wall surface 13 extending continuously from the peripheral wall surface 11 to the center (rotational shaft 2) of the stirred tank 1, then moves upward, and returns to the bottom wall, thereby forming a small secondary circulating flow Rb. In this secondary circulating flow Rb, the stirring object M is circulated and thereby stirred, as well.

In the stirring apparatus according to this embodiment, the gap (clearance) between the lower edge of the bottom blade 30 and the bottom wall surface 13 of the stirred tank 1 is set to satisfy the condition: 1% of the inner diameter of the stirred tank 1<the clearance<4.5% of the inner diameter of the stirred tank 1. Accordingly, as described above, when the bottom blade 30 rotates, liquid exchange is made between the primary circulating flow Ra and the secondary circulating flow Rb.

Then, since liquid exchange is made between the primary circulating flow Ra and the secondary circulating flow Rb formed in the laminar flow region, no portion with the stirring object stagnated therein is formed, and thus excellent stirring can be made in a short time. Although not shown, according to the stirring apparatus of this embodiment, in the regions other than the laminar flow region, the stirring object collided with the peripheral wall surface 11 is not separated into an upward flow and a downward flow, and instead, it moves upward to the vicinity of the liquid level along the peripheral wall surface 11, then moves to the center of the stirred tank in the vicinity of the liquid level, then moves downward at the center of the stirred tank, and then returns to the bottom blade, thereby forming a large circulating flow in the entire stirred tank. Whereby, the stirring apparatus of this embodiment makes it possible to achieve excellent stirring in a short time even for the regions other than the laminar flow region.

As described above, in the stirring apparatus according to this embodiment, the independency between the primary circulating flow Ra and the secondary circulating flow Rb is broken and thus liquid exchanging becomes possible by setting the clearance between the lower edge of the bottom blade 30 and the bottom wall surface 13 of the stirred tank 1, the clearance satisfying the following condition: 1% of the inner diameter of the stirred tank 1<the clearance<4.5% of the inner diameter of the stirred tank 1, in which a stirring object of the primary circulating flow Ra is pumped by the bottom blade 30, moves upward to the vicinity of the liquid level, moves to the center of the stirred tank 1 in the vicinity of the liquid level, moves downward at the center of the stirred tank 1, and then returns to the bottom blade 30; and a stirring object of the secondary circulating flow Rb is pumped by the bottom blade 30, moves along the bottom wall surface 13, moves upward at the center of the stirred tank 1, and then returns to the bottom blade 30. Thus, stirring can be made even in a laminar flow region in a short time, and thus the stirring apparatus makes it possible to achieve excellent stirring in a wide range of viscous regions and achieve reduction in mixing time (shorten the mixing time).

### Example 1

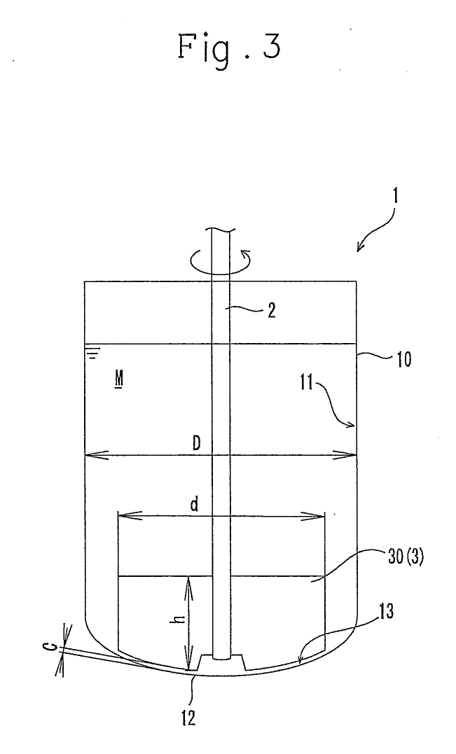

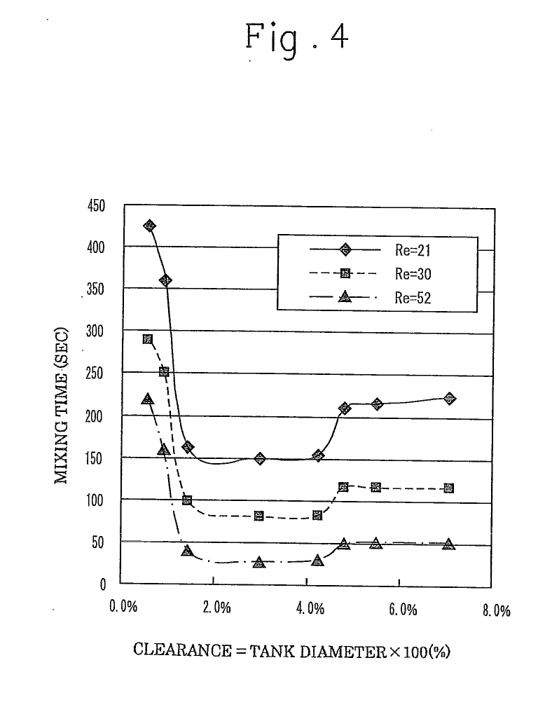

Here, the present inventors performed an experiment to confirm what to set the clearance between the lower edge of the bottom blade 30 and the bottom wall surface 13 of the stirred tank 1. In the experiment, the stirring impeller 3 having only the bottom blade 30 was used without providing the latticed blade 31 of the above-mentioned embodiment, as shown in FIG. 3. FIG. 4 is a graph obtained by plotting the results of the experiment and drawing an approach line.

### Experimental Conditions

Tank Diameter (inner diameter of the peripheral wall 1 of the stirred tank 1) D: 354 mm

Impeller Diameter (diameter of the bottom blade 30) d: 255 mm
Impeller Height (distance from the lowermost edge to the uppermost edge, of the bottom blade 30) h: 300 mm

Shape of the bottom 12 (bottom wall surface 13) of the stirred tank 1: semi-elliptical arc shape

Shape of the bottom blade 30: flat plate shape in which the lower edge has a semi-elliptical arc shape conforming to the bottom wall surface 13

Clearance C: 0.3% of the inner diameter of the stirred tank 1 to 7.1% of the inner diameter of the stirred tank 1
Amount of Liquid: 35.4 Litters
Reynolds Number: Re=21, Re=30, Re=52

Reynolds Number is Re=ρ·n·d²/μ (where ρ is a density [kg/m³] of the stirring object M, d is the impeller diameter [m], μ is a viscosity [Pa·s] of the stirring object M, and n is the rotation speed [1/s]).

### Experimental Method

The mixing time from the start of stirring to the removal of a stagnated region (non-stirred region) was measured by the use of a decoloring method using a chlorine indicator. That is, the progress of decoloration was observed and the time until the decoloring is completed was measured by coloring the liquid in the stirred tank 1 with bromocresol plus sodium hydroxide (NaOH) into a dark purple and performing the stirring after adding a hydrochloric acid solution (HCL) thereto. This method is a widely known method which is disclosed, for example, in Lamberto D. J., Muzzio F. J., Swanson P. D., Tonkovich A. L. Chemical Engineering Science, 51 P733-P741 (1996).

On the basis of the experimental method mentioned above, the experiment was performed while varying the rotation speed of the bottom blade 30 for the stirring object M having constant viscosity and density so that the Reynolds number is Re=21, Re=30, and Re=52 and varying the clearance C between the bottom wall surface 13 of the stirred tank 1 and the lower edge of the bottom blade 30 with reference to the inner diameter D of the stirred tank 1. As a result, it could be seen from FIG. 4 that the stirring treatment was completed in a short time when the clearance between the lower edge of the bottom blade 30 and the bottom wall surface 13 satisfies the condition: 1% of the inner diameter of the stirred tank 1<the clearance C<4.5% of the inner diameter of the stirred tank 1 in any of the Reynolds number of Re=21, RE=30, and R=52. That is, it could be seen that the mixing time tends to be elongated when the clearance C between the lower edge of the bottom blade 30 and the bottom wall surface 13 is in the range: 1% of the inner diameter of the stirred tank 1≧clearance C≦4.5% of the inner diameter of the stirred tank 1.

The present invention is not limited to the above-mentioned embodiment, but may be modified in various forms without departing from the gist of the present invention.

Although the stirring impeller 3 in which the bottom blade 30 and the latticed blade 31 are combined together is employed in the above-mentioned embodiment, the present invention is not necessarily limited thereto. For example, as shown in the example, the stirring impeller 3 may be made up of only the bottom blade 30, or the stirring impeller 3 may be made up of the combination of another type of blade (such as a turbine blade, an anchor blade and a propeller blade) and the bottom blade 30, in place of the latticed blade 31.

Although a baffle plate is not disposed in the stirred tank 1 in the above-mentioned embodiment, the present invention is not necessarily limited thereto. For example, a baffle plate extending from the inner peripheral surface of the peripheral wall 10 of the stirred tank 1 toward the center thereof may be provided. In this case, it is apparent that the same functions and advantages as those of the above-mentioned embodiment can be obtained by setting the clearance between the stirred tank 1 and the bottom blade 30 to an optimal range.

Although the bottom blade 30 having a flat plate shape has been employed as the bottom blade 30 in the above-mentioned embodiment, the present invention is not necessarily limited thereto. For example, the bottom blade 30 may have a shape in which a portion close to rotation shaft 2 is formed into a flat plate shape and a portion close to the outer end is curved in the rotation direction or may have a plate shape and be twisted from a portion close to the rotation shaft 2 toward the outer end. That is, the bottom blade 30 may have any shape, so long as the lower edge thereof has a shape conforming to the bottom wall surface 13 of the stirred tank 1 and the bottom blade 30 rotates around the rotation shaft 2 concentric or substantially concentric with the stirred tank 1.

1. A stirring apparatus comprising a stirred tank having a bottomed cylinder shape, a rotation shaft concentrically or substantially concentrically disposed inside the stirred tank, and a bottom blade that extends from the rotation shaft so as to extend in a radial direction and a vertical direction, of the stirred tank, a lower edge of the bottom blade having a shape conforming to a bottom wall surface of the stirred tank, wherein a clearance is formed between the lower edge of the bottom blade and the lower wall surface and the clearance satisfies the following condition:
1% of the inner diameter of the stirred tank<the clearance<4.5% of the inner diameter of the stirred tank.
